(19) United States
(12) Patent Application Publication
(10) Pub. No.: US 2023/0297829 A1
(43) Pub. Date: Sep. 21, 2023

(54) METHOD AND SYSTEM FOR TRAINING SELF-CONVERGING GENERATIVE NETWORK

(71) Applicant: Hansung University Industry-University Cooperation Foundation, Seoul (KR)

(72) Inventors: Sung Hoon JUNG, Seoul (KR); HoJoong KIM, Seoul (KR)

(21) Appl. No.: 17/905,677

(22) PCT Filed: Mar. 11, 2020
(86) PCT No.: PCT/KR2020/003347

§ 371 Date: Mar. 6, 2023

(30) Foreign Application Priority Data
Mar. 5, 2020 (KR) 10-2020-0027659

(51) Int. Cl. G06N 3/08; G06N 3/0475

(52) U.S. Cl. CPC G06N 3/08; G06N 3/0475

(57) ABSTRACT

A method and system for training a self-converging generative network are disclosed. A method for training a self-converging generative network according to one embodiment of the present invention comprises the steps of: pairwise-mapping training images and latent space vectors constituting a training data set; defining a loss function for a generator of the self-converging generative network and a loss function for a latent space; and training weights and latent vectors of the self-converging generative network using the loss function for the generator and the loss function for the latent space.

### TECHNICAL FIELD

The present invention relates to a method and system for training a self-converging generative network, and more particularly, to a self-converging generative network in which a latent space and an image space gradually converge using a single network.

### RELATED ART

Currently, a great development has been made in terms of image recognition or classification through research using a deep neural network (DNN), particularly, a convolution neural network (CNN). In addition to simply recognizing or classifying an image, research on a generative model for generating an image is also being actively conducted. Dissimilar to a classification model, the generative model refers to a model configured to generate data from a latent space and importance and use thereof are increasing. In general, the generative model may be a model that may generate data and application thereof is not limited to generating data. Since being able to generate data indicates having all information on the data, many issues related to the data may be solved.

Generative models that are actively studied in the recent times include a variational auto-encoder (VAE) and a generative adversarial network (GAN). These two models represent a method of directly learning an image in pixel units and a method of indirectly learning an image. The VAE generally uses a pixel-wise loss of learning an image by directly comparing pixel values of the image. The GAN refers to a method of learning through competitive training using an adversarial loss of a discriminator and a generator and may be a method of indirectly learning an image through the discriminator, which differs from the pixel-wise loss. The VAE and GAN are both generative models designed to create images from a latent space, but use different methods to learn images, resulting in different characteristics in the images they generate.

In the case of the pixel-wise loss, a training image is directly learned in a pixel space rather than explicitly considering the structure or properties of the underlying image manifold and thus, an image to which average effect of training images is applied is generated, which generally shows producing a blurry image compared to the GAN. In particular, in the case of the VAE, since a plurality of images may be learned in a single latent space by sampling and training a latent vector, this tendency is more prominent. In the case of adversarial loss, since loss is not calculated in pixel units, training is performed to approximate data present in image manifold and blurry effect is generally less. Due to this characteristic, the adversarial loss currently results in producing a more realistic image than the pixel-wise loss in generating an image. However, although the GAN shows excellent results in terms of resulting images, the GAN also has many disadvantages.

There are some disadvantages of the GAN. They arise since a generator is trained through a discriminator rather than direct training through pixel differences. First, it is difficult to balance the generator and the discriminator. There are some methods for well training of the generator and the discriminator. However, nonetheless, training of the generator and the discriminator is not well performed if parameters are slightly mismatched or if a structural design is not matched at all. Second is mode collapsing that represents a phenomenon of outputting a few training data when generating samples through a GAN model. Currently, studies are being conducted for balancing, but mode collapsing still frequently occurs in a GAN structure. However, such issues arise from a structural problem of a model and thus, are not easy to fundamentally solve. Therefore, it is necessary to generate a new generative model that generates a clearer image than the VAE without causing mode collapsing. In the new generative model, it may be good to perform training without sampling as much as possible to generate a sharp image. To this end, a new method of training a latent space is required. Also, it may be good to decrease an amount of calculation by reducing the number or a size of necessary networks as much as possible.

### DETAILED DESCRIPTION OF THE INVENTION

### Technical Subject

Example embodiments of the present invention provide a self-converging generative network (SCGN) that allows a latent space and an image space to gradually converge into a single network.

### Solution

A video frame interpolation method between consecutive first and second frames of a video sequence according to an example embodiment of the present invention includes and a self-converging generative network training method according to an example embodiment includes mapping, as a pair, a training image and a latent space vector that constitute a training dataset; defining a loss function for a generator of the self-converging generative network and a loss function for a latent space; and training a weight and a latent vector of the self-converging generative network using the loss function for the generator and the loss function for the latent space.

The training may include training the latent vector to follow a normal distribution using a loss function derived from a pixel-wise loss and Kullback-Leibler (KL) divergence.

The training may include training the self-converging generative network such that the latent space self-converges and follows a normal distribution in a training process.

The mapping may include randomly initializing the latent space using a normal distribution of a preset standard deviation and pairing the latent space and an image space, thereby one-to-one mapping the latent space and the image space.

The defining may include defining the loss function of the self-converging generative network by acquiring a relationship between the latent space and an image space and by limiting the latent space within a preset target space using KL divergence.

The training may include alternately training the weight and the latent vector of the self-converging generative network.

A self-converging generative network training system according to an example embodiment includes a mapping unit configured to map, as a pair, a training image and a latent space vector that constitute a training dataset; a definition unit configured to define a loss function for a generator of the self-converging generative network and a loss function for a latent space; and a training unit configured to train a weight and a latent vector of the self-converging generative network using the loss function for the generator and the loss function for the latent space.

The training unit may be configured to train the latent vector to follow a normal distribution using a loss function derived from a pixel-wise loss and KL divergence.

The training unit may be configured to train the self-converging generative network such that the latent space self-converges and follows a normal distribution in a training process.

The mapping unit may be configured to randomly initializing the latent space using a normal distribution of a preset standard deviation and pairing the latent space and an image space, thereby one-to-one mapping the latent space and the image space.

The definition unit may be configured to define the loss function of the self-converging generative network by acquiring a relationship between the latent space and an image space and by limiting the latent space within a preset target space using KL divergence.

The training unit may be configured to alternately train the weight and the latent vector of the self-converging generative network.

### Effect of Invention

According to example embodiments of the present invention, there may be provided a self-converging generative network (SCGN) including a single network to be structurally simple and to allow a latent space and an image space to gradually converge. Through this, since there is no need to sample the latent space as in a variational auto-encoder (VAE), it is possible to alleviate an issue that a generated image is blurred. Dissimilar to a generative adversarial network (GAN), since it is possible to be aware of mapping between the converged latent space and an output image, a desired image may be easily generated when generating an image. Since training is performed through one-to-one mapping between the latent space and a training image, mode collapsing does not occur and it is easy to perform training.

The present invention may also be used for video compression.

### BRIEF DESCRIPTION OF DRAWINGS

FIG. 1 is a flowchart illustrating a self-converging generative network (SCGN) training method according to an example embodiment of the present invention.

FIG. 2 illustrates a structure of a SCGN according to an example embodiment of the present invention.

FIG. 3 illustrates an example structure of a generator network of an SCGN model.

FIG. 4 illustrates components of a loss function.

FIGS. 5a, 5b, 5c, 5d 6a, 6b and 6c illustrate examples of generated images and spatial continuity of an SCGN (a) compared with results of DFC-VAE (b) and boundary equilibrium generative adversarial networks (BEGAN) (c) models.

### BEST MODE

Advantages and features of the present invention and methods of achieving the same will become clear with reference to example embodiments described in detail with the accompanying drawings. However, the present invention is not construed as being limited to the example embodiments disclosed below and will be implemented in various forms different from each other. The example embodiments are provided to make the disclosure of the present invention complete and to inform the category of the present invention to one of ordinary skill in the art to which the present invention pertains and the present invention is only defined by the category of the claims.

The terminology used herein is for the purpose of describing the example embodiments only and is not to be limiting the present invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated components steps, operations, and/or elements, but do not preclude the presence or addition of one or more other components, steps, operations, and/or elements.

Unless otherwise defined herein, all terms used herein (including technical or scientific terms) have the same meanings as those generally understood by one of ordinary skill in the art. Also, terms defined in dictionaries generally used should be construed to have meanings matching contextual meanings in the related art and are not to be construed as an ideal or excessively formal meaning unless otherwise defined herein.

Hereinafter, example embodiments of the present invention will be described in detail with reference to the accompanying drawings. Like reference numerals refer to like components throughout and repeated description related thereto will be omitted.

Example embodiments of the present invention provide a self-converging generative network (SCGN) in which a latent space and an image space gradually converge using a single network.

Here, dissimilar to other generative models, the SCGN relates to self-converging to a latent space suitable for training data by training the latent space as well as a model and may be a model that balances between the latent space and the model in a training process. That is, the SCGN does not need to sample the latent space as in a variational auto-encoder (VAE) and thus, may alleviate an issue that a generated image is blurred, and, dissimilar to a generative adversarial network (GAN), may be aware of mapping between the converged latent space and an output image and thus, may easily generate a desired image when generating an image, and may be trained through one-to-one mapping between the latent space and a training image. Therefore, mode collapsing does not occur and it is easy to perform training.

The SCGN refers to a model that self-finds a relationship between a latent space and training data by using a randomly formed latent space and a model. Also, the SCGN refers to a model that may be used when generating actual data by allowing the randomly formed latent space to converge into a specific probability distribution space.

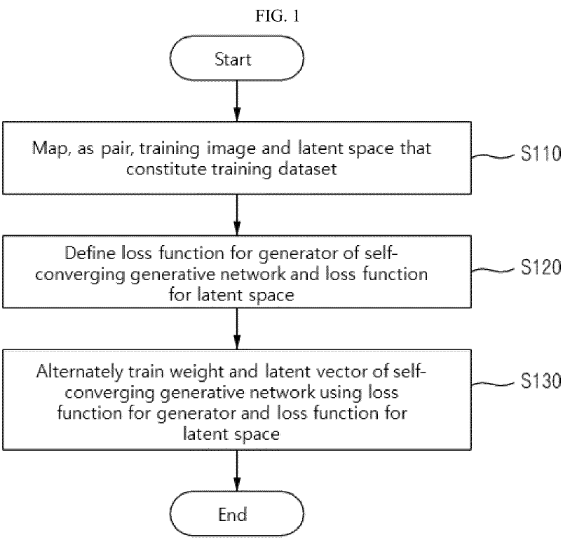

FIG. 1 is a flowchart illustrating an SCGN training method according to an example embodiment of the present invention.

Referring to FIG. 1, the SCGN training method of the present invention includes operation S110 of mapping, as a pair, a training image and a latent space that constitute a training dataset; operation S120 of defining a loss function for a generator of the SCGN and a loss function for the latent space; and operation S130 of alternately training a weight and a latent vector of the self-converging generative network using the loss function for the generator and the loss function for the latent space.

In operation S110, the latent space and an image space may be one-to-one mapped and maintained by randomly initializing the latent space using a normal distribution of a preset standard deviation and by pairing the latent space and the image space.

In operation S120, the loss function of the SCGN may be defined by acquiring a relationship between the latent space and the image space and by limiting the latent space within a preset target space using Kullback-Leibler (KL) divergence.

In operation S130, the latent vector may be trained to follow a normal distribution using a loss function derived from a pixel-wise loss and KL divergence.

Also, in operation S130, the SCGN may be trained such that the latent space self-converges and follows a normal distribution in a training process.

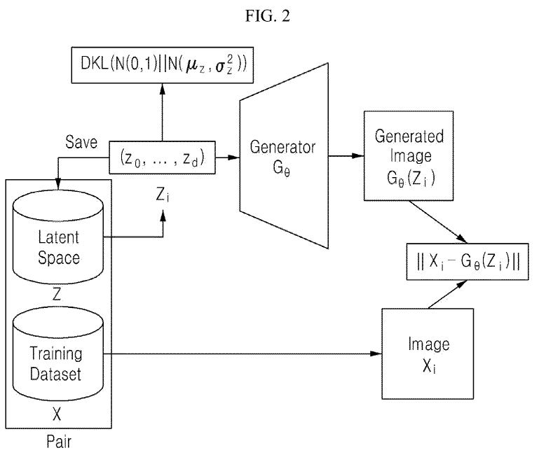

Hereinafter, the method of the present invention is further described with reference to FIGS. 2 to 6.

With the assumption of generating a simplest generative model, this generative model uses a neural network capable of serving as a universal function approximator and maps Z that is an input to X that is an image through the neural network. That is, it may be regarded as finding θ of the model that converts the latent space to the image space.

To provide an example using the Modified National Institute of Standards and Technology (MNIST) dataset, the Z variable in this model represents a normally distributed vectors. By using the function fθ(Z), the model can generate an image corresponding to a specific Z value. In a stochastic framework, the distribution p(Z) is used as input for the model. The latent space, represented by the distribution of Z, is then used to output the image distribution X. The model can be trained to learn the optimal values for θ and Z that maximize the likelihood of generating the corresponding image.

In this manner, an integral equation including only distributions of the present invention may be simply generated using a marginal probability distribution. This may be regarded as inferring a distribution of X that is a distribution of images. However, it is very difficult to perform an actual calculation using this integral equation. In this case, an expectation-maximization (EM) algorithm using a posterior probability distribution may be a solution. However, it is difficult to infer the posterior probability distribution using the neural network as a model and this method may not be readily applied since the EM algorithm is a model that may be applied to relatively simple data. Therefore, if there is only one model, a new method is required for solution.

Although the aforementioned marginal probability distribution includes the integral equation and thus is not used as is, a method of acquiring an approximate value may be used using Jensen’s inequality. This method may acquire a log likelihood when parameter θ is given for a single image. If the model is optimized through the corresponding method, the model may be trained with n samples Z for a single image.

It is an ideal result to learn various images in the normal distribution as described above. However, if the images are actually learned, a result image may be inferred as an average pixel value of all MNIST data. This happens since all the images are learned in the same space and currently on the normal distribution. To make this training method possible, a suitable distribution needs to be known for each image.

For example, if a location of an image in the latent space and a method of generating a distribution for an ideal relationship between two are known, optimal θ may be acquired. As the distribution is more delicate a generative model may generate a more realistic image. For example, it is assumed that a distribution representing an image becomes very small and a single image has a single point of Z. However, since this relationship is not actually known, where Z needs to be located may not be known. In this case, if Z is randomly initialized and then is randomly paired with X, image X to be learned becomes clear when Z is given.

In this manner, Z as well as θ may be acquired through training. Since a loss may be acquired through a difference between images, Z as well as θ may be trained through backpropagation. Here, when a generator and Z are alternately trained, they may gradually converge while being positioned.

Further description is made below. The SCGN of the present invention is explained as a probabilistic model. P denotes a model distribution, Q denotes a target distribution, Z denotes a variable of the latent space, and X denotes a variable of training data. In the generative model of the present invention, mapping from P(Z) to P(X) is required. To identify a relationship between P(Z) and P(X), P(X|Z) is trained. P(Z) may be trained to learn manifold with the assumption that P(Z) and P(X) are randomly mapped in an initial stage of training.

However, if Z changes with training, P(Z) may not be known. To use this as the generative model, P(Z) needs to be generated to follow the target distribution Q(Z). To define a loss function of the SCGN, two matters need to be considered. Initial, a relationship between the latent space and the image space is acquired, which may be expressed as logP(X|Z). If logP(X|Z) is calculated, logP(X) may be acquired as shown in the following Equation 1.

$$log \text{P} \left(\text{X}\right) {\text{= IE}}_{\text{Z-P}} \left[\text{log P} \left(\text{X} \left|\text{Z}\right)\right)\right] \qquad \text{[Equation 1]}$$

Based on the above Equation 1, the present invention uses a single loss function of the SCGN as a pixel-wise loss. Second, the latent space Z is limited within the target space using KL divergence. Here, the KL divergence may be expressed as shown in the following Equation 2.

$$\begin{matrix}{\text{D}}_{\text{KL}} \left(\text{Q} \left(\text{Z}\right) \text{P} \left(\text{Z}\right)\right) = \\ \left|{\text{E}}_{\text{Z} - \text{Q}} \left[log \text{P} \left(\text{X} \left|\text{Z}\right)\right)\right] - log \text{P} \left(\text{X}\right) + {\text{D}}_{\text{KL}} \left(\text{Q} \left(\text{Z}\right) \left‖\text{P} \left(\text{Z} \left|\text{X}\right)\right)\right)\right)\right)\end{matrix} \qquad \text{[Equation 2]}$$

The KL divergence may be used in another loss function of the SCGN for P(Z) to follow the target distribution Q(Z). Between the above two matters, the loss function of the present invention may be specified. Here, the distribution P may represent a distribution at a point in time of training and the distribution Q may represent a distribution to which Z desires to converge. First of all, the KL divergence of the distribution P(Z) and the target distribution Q(Z) currently present may be viewed at a time of training. If the KL divergence of the two is minimized, the distribution of Z may become closer to the target distribution without being affected by X. The present invention may calculate the KL divergence as in the above Equation 2 by separating the KL divergence into three terms through modification thereof.

For the KL divergence of the above Equation 2, the three terms may be largely divided into a part related to X and a part related to Z. Here, X denotes an image and Z denotes a latent space. Therefore, the three terms may be regarded as being divided into an image part and a latent space part. The first two terms among terms on the right of the above Equation 2 relate to the image and make the image close to a dataset with the assumption that current Z follows the distribution of Q. All the terms on the right, that is, three terms relate to Z and minimize a difference between the KL divergence and the image on Z in consideration of the current image and the distribution of Z.

FIG. 2 illustrates a structure of a self-converging generative network (SCGN) according to an example embodiment of the present invention and illustrates an SCGN including only a single generator Gθ. The present invention may use two loss functions, loss function for generator g, L_{Gθ}, and loss function for latent space Z, L_{Z}. Here, the two loss functions may be represented as the following Equation 3.

$$\begin{matrix}{\text{L}}_{{\text{G}}_{\text{θ}}} = {\sum }_{\text{i} = 1}^{\text{n}} \left\{\left‖{\text{x}}_{\text{i}} - {\text{G}}_{\text{θ}} \left({\text{z}}_{\text{i}}\right)\right‖\right\} \\ {\text{L}}_{\text{Z}} = {\sum }_{\text{i=1}}^{\text{n}} \left\{\left‖{\text{X}}_{\text{i}} - {\text{G}}_{\text{θ}} \left({\text{z}}_{\text{i}}\right)\right‖\right\} + \text{λ} ⋅ \frac{1}{2} {\sum }_{\text{d=1}}^{\text{m}} \left(log {\text{σ}}_{2 \text{d}} - 1 + \frac{1 + {μ}_{20}}{{\text{σ}}_{20}}\right)\end{matrix} \qquad \text{[Equation 3]}$$

In Equation 3, λ denotes a parameter for adjusting balance between a pixel-wise loss and a corresponding loss using KL divergence and a value of λ may be fixed or may dynamically vary according to an epoch. For example, a value of λ may gradually increase according to an epoch. In a training process, the two loss functions are alternately applied to acquire a one-to-one relationship between Z and X and to make Z follow the normal distribution through self-convergence of the latent space Z. The latent space gradually learns manifold and maintains spatial continuity of the training image X.

Also, the present invention may use L1 loss as the pixel-wise loss to reduce a difference between images. When using the pixel-wise loss, it is less sensitive to an outlier than when using mean squared error (MSE), which less generates a blurry image. To outperform blurring of an image, the present invention may more realistically express an image using a perceptual loss in addition to using the L1 loss. This is a training method using a difference in features of a visual geometry group (VGG) model. Also, with the assumption that a distribution of Z is a normal distribution to make it easy to calculate the KL divergence, the KL divergence between normal distributions may be calculated. That is, if the loss function is defined, the loss function may be defined as the loss function of the generator and the loss function of the latent space, largely including three parts, image loss, perceptual loss, and regularization loss, which may be represented as the following Equation 4.

$$\begin{matrix}{\text{L}}_{\text{G}} {}_{{}_{\text{θ}}} {\sum }_{\text{i=1}}^{\text{n}} \frac{\text{image loss}}{\left[\left|{\text{x}}_{\text{i}} - {\text{G}}_{\text{θ}} \left({\text{z}}_{\text{i}}\right)\right| +\right)} \frac{\text{perceptual loss}}{\left({\left\{ϕ \left({\text{x}}_{\text{i}}\right) - ϕ \left({\text{G}}_{\text{θ}} \left({\text{z}}_{\text{i}}\right)\right)\right\}}^{2}\right]} \\ {\text{L}}_{{\text{G}}_{\text{θ}}} = {\sum }_{\text{i=1}}^{\text{n}} \frac{\text{image loss}}{\left[\left|{\text{x}}_{i} - {\text{G}}_{\text{θ}} \left({\text{z}}_{\text{i}}\right)\right| +\right)} \frac{\text{perceptual loss}}{\left({\left\{ϕ \left({\text{x}}_{\text{i}}\right) - ϕ \left({\text{G}}_{\text{θ}} \left({\text{z}}_{\text{i}}\right)\right)\right\}}^{2}\right]} + \\ \frac{\text{regularization loss}}{\text{λ} ⋅ \frac{1}{2} {\sum }_{\text{d=1}}^{\text{m}} \left(log {\text{σ}}_{{2}_{\text{d}}} - 1 + \frac{1 = {μ}_{{2}_{σ}}}{{\text{σ}}_{{Ζ}_{\text{d}}}}\right)}\end{matrix} \qquad \text{[Equation 4]}$$

In Equation 4, λ denotes a parameter for adjusting a weight of the regularization loss since there is a role of obstructing convergence when power of the regularization loss is too great.

The following algorithm 1 presents an entire training process of the SCGN and the latent space Z is randomly initialized using a normal distribution with a small standard deviation. Here, the small standard deviation is helpful to train the SCGN with training data since a short distance of latent vector of Z is easy to converge. The latent space Z is paired with the image space X. If the two variables are one-to-one mapped, each variable of Z may be trained for each piece of training data X. Here, Z and Gθ may be alternately trained, which is to ensure that the latent space may be mapped to a specific distribution while the latent space Z is paired with the training image X.

Algorithm 1 Training of SCGN
//k: number of steps required for one epoch//
G_{θ},Z ← initialize parameters
make pairs of X and Z randomly
for number of training iterations do
for k steps do
g₂ ← ∇₂ calculate derivative values through L_{z}
Z ← update parameters using gradients g_{z}
g_{G_{θ}} ← ∇_{G_{θ}} calculate derivative values through L_{G_{θ}}
G_{θ} ← update parameters using gradients g_{G_{θ}}
end for
end for

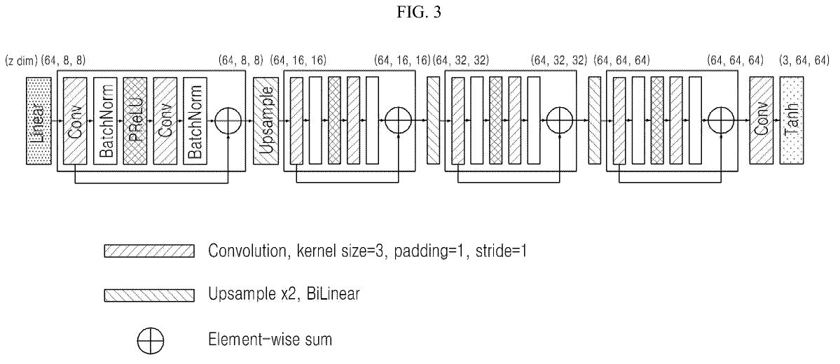

FIG. 3 illustrates an example structure of a generator network of an SCGN model. Referring to FIG. 3, the generator network uses a plurality of residual connections to avoid a gradient loss issue when a latent vector is trained. Also, the present invention performs upsampling to improve a resolution of an output image. A remaining part of the model of the present invention may be configured as a generally used module. That is, the generator network of the SCGN of the present invention may be smoothly trained using a residual connection block structure even though a network deepens. All the convolutions use a 3×3 kernel, padding and stride are given as 1, and upsampling is performed for each block excluding a last block. Here, an image size may be upsampled by a factor of 2 through a simple BiLinear operation without using a convolution.

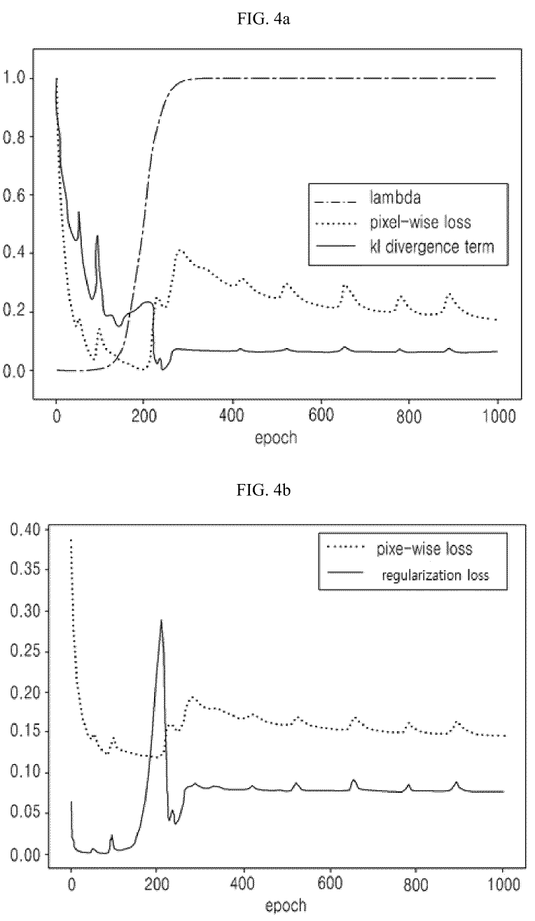

FIG. 4 illustrates components of a loss function. FIG. 4A illustrates a pixel-wise loss, a divergence loss, and a value of λ during training of an SCGN and FIG. 4B illustrates actual values of a pixel-wise loss and a regularization loss. Referring to FIG. 4A, a pixel-wise loss value and a KL divergence value are logarithmic and then regularized for comparison to a value of λ. Referring to FIG. 4B, the regularization loss value corresponds to a value multiplied by the KL divergence value and the value of λ. Here, if the value of λ is too small, training is focused on one-to-one mapping between a latent vector and an image and a generated image may be less blurry, but it may be difficult to maintain spatial continuity. On the contrary, if the value of λ is too high, regularization strength for the latent vector becomes too strong and thus, it is difficult for the latent vector to find an appropriate location in the latent space. Therefore, the present invention may use the above both by gradually increasing λ in the training process.

The present invention may train a generator and a latent vector by setting a batch size to 1024 to experiment the SCG with CelebA dataset. This is because the larger the number of samples, the better approximation of the target distribution in training.

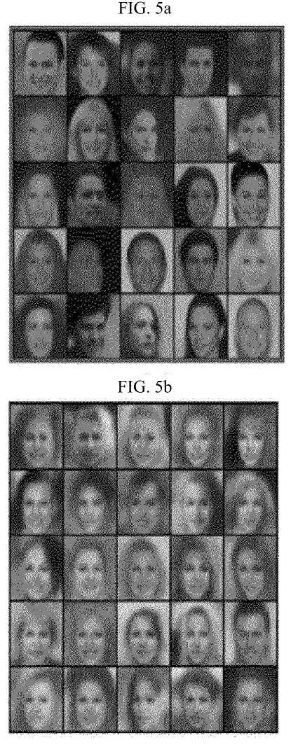

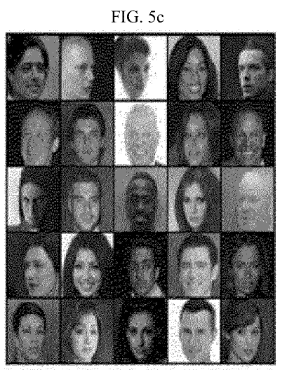

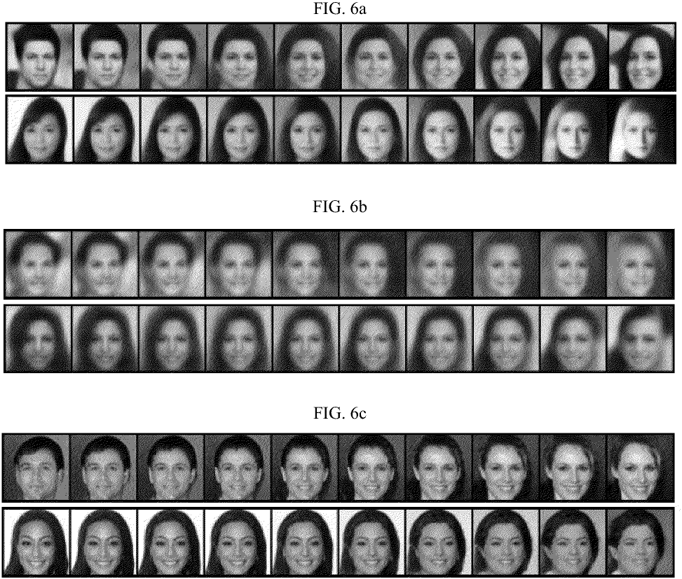

FIGS. 5 and 6 illustrate examples of generated images and spatial continuity of an SCGN (a) compared with results of DFC-VAE (b) and boundary equilibrium generative adversarial networks (BEGAN) (c) models. Here, the DFC-VAE and the BEGAN have a network structure similar to that of the SCGN, but is about twice or three times more complex than the SCGN.

Referring to FIGS. 5 and 6, the SCGN generates a less blurry image than the VAE and generates an image similar to an image generated by the BEGAN. It is very important that a generative model not only successfully generates an image in a pixel space and has continuity in a manifold space. It is more difficult for the SCGN of the present invention to form spatial continuity than other models since the latent vector includes specific values rather than values given through distribution sampling. However, referring to FIG. 6, the spatial continuity of the SCGN is well constructed. Also, although the SCGN shows less clear results than the BEGAN, but is advantageous in terms of learning the entire data without mode collapsing.

As described above, the present invention provides a self-converging generative network (SCGN) including a single network such that a latent space and an image space may gradually converge. Through this, since there is no need to sample the latent space as in a VAE, it is possible to alleviate an issue that a generated image is blurred. Dissimilar to a GAN, since it is possible to be aware of mapping between the converged latent space and an output image, a desired image may be easily generated when generating an image. Since training is performed through one-to-one mapping between the latent space and a training image, mode collapsing does not occur and it is easy to perform training.

Also, the SCGN according to an example embodiment of the present invention have some advantages compared to the existing models. First, the SCGN is a model that is easy to train without mode collapsing that often occurs in a GAN. Second, the SCGN is a mode that may generate a less blurry and realistic image rather than a VAE method. Third, the SCGN may relatively easily infer a latent space through a relationship between Z and X. Fourth, the SCGN may be trained less sensitively to a parameter compared to a GAN model. Also, the SCGN according to an example embodiment of the present invention may be used for video compression.

The method according to example embodiments of the present invention may be implemented as a system. The system may include a conceptual component that performs each operation. For example, a self-converging generative network (SCGN) training system according to an example embodiment may include a mapping unit configured to map, as a pair, a training image and a latent space that constitute a training dataset; a definition unit configured to define a loss function for a generator of the SCGN and a loss function for the latent space; and a training unit configured to alternately train a weight and a latent vector of the SCGN using the loss function for the generator and the loss function for the latent space.

The mapping unit may one-to-one map the latent space and an image space by randomly initialize the latent space using a normal distribution of a preset standard deviation and by pairing the latent space and the image space.

The definition unit may define the loss function of the SCGN by acquiring a relationship between the latent space and an image space and by limiting the latent space within a preset target space using KL divergence.

The training unit may train the latent vector to follow a normal distribution using a loss function derived from a pixel-wise loss and KL divergence.

Also, the training unit may train the SCGN such that the latent space may self-converge and follow a normal distribution in a training process.

It will be apparent to those skilled in the art that the system according to example embodiments of the present invention may contain all the contents described above with reference to FIGS. 1 to 6.

The systems or the apparatuses described herein may be implemented using hardware components, software components, and/or a combination thereof. For example, the systems, the apparatuses, and the components described herein may be implemented using one or more general-purpose or special purpose computers, such as, for example, a processor, a controller, an arithmetic logic unit (ALU), a digital signal processor, a microcomputer, a field programmable array (FPA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be permanently or temporarily embodied in any type of machine, component, physical equipment, virtual equipment, a computer storage medium or device, or a transmitted signal wave to be interpreted by the processing device or to provide an instruction or data to the processing device. The software also may be distributed over network coupled computer systems so that the software is stored and executed in a distributed fashion. The software and data may be stored by one or more computer readable storage media.

The methods according to the above-described example embodiments may be configured in a form of program instructions performed through various computer devices and recorded in non-transitory computer-readable media. The media may also include, alone or in combination with the program instructions, data files, data structures, and the like. The program instructions recorded in the media may be specially designed and configured for the example embodiments or may be known to those skilled in the computer software art and thereby available. Examples of the media include magnetic media such as hard disks, floppy disks, and magnetic tapes; optical media such as CD-ROM and DVD; magneto-optical media such as floptical disks; and hardware devices that are specially configured to store program instructions, such as read-only memory (ROM), random access memory (RAM), flash memory, and the like. Examples of program instructions include both machine code, such as produced by a compiler, and files containing higher level code that may be executed by the computer using an interpreter. The hardware device may be configured to operate as at least one software module to perform an operation of the example embodiments, or vice versa.

While the example embodiments are described with reference to specific example embodiments and drawings, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, or replaced or supplemented by other components or their equivalents.

Therefore, other implementations, other example embodiments, and equivalents of the claims are to be construed as being included in the claims.

What is claimed is:

1. A method of training a self-converging generative network, the method comprising:
mapping, as a pair, a training image and a latent space vector that constitute a training dataset;
defining a loss function for a generator of the self-converging generative network and a loss function for a latent space; and
training a weight and a latent vector of the self-converging generative network using the loss function for the generator and the loss function for the latent space.

2. The method of claim 1, wherein the training comprises training the latent vector to follow a normal distribution using a loss function derived from a pixel-wise loss and Kullback-Leibler (KL) divergence.

3. The method of claim 1, wherein the training comprises training the self-converging generative network such that the latent space self-converges and follows a normal distribution in a training process.

4. The method of claim 1, wherein the mapping comprises randomly initializing the latent space using a normal distribution of a preset standard deviation and pairing the latent space and an image space, thereby one-to-one mapping the latent space and the image space.

5. The method of claim 1, wherein the defining comprises defining the loss function of the self-converging generative network by acquiring a relationship between the latent space and an image space and by limiting the latent space within a preset target space using KL divergence.

6. The method of claim 1, wherein the training comprises alternately training the weight and the latent vector of the self-converging generative network.

7. A system for training a self-converging generative network, the system comprising:
a mapping unit configured to map, as a pair, a training image and a latent space vector that constitute a training dataset;
a definition unit configured to define a loss function for a generator of the self-converging generative network and a loss function for a latent space; and
a training unit configured to train a weight and a latent vector of the self-converging generative network using the loss function for the generator and the loss function for the latent space.

8. The system of claim 7, wherein the training unit is configured to train the latent vector to follow a normal distribution using a loss function derived from a pixel-wise loss and Kullback-Leibler (KL) divergence.

9. The system of claim 7, wherein the training unit is configured to train the self-converging generative network such that the latent space self-converges and follows a normal distribution in a training process.

10. The system of claim 7, wherein the mapping unit is configured to randomly initialize the latent space using a normal distribution of a preset standard deviation and to pair the latent space and an image space, thereby one-to-one mapping the latent space and the image space.

11. The system of claim 7, wherein the definition unit is configured to define the loss function of the self-converging generative network by acquiring a relationship between the latent space and an image space and by limiting the latent space within a preset target space using KL divergence.

12. The system of claim 7, wherein the training unit is configured to alternately train the weight and the latent vector of the self-converging generative network.
